(19) United States
(12) Patent Application Publication
(10) Pub. No.: US 2017/0337816 A1
(43) Pub. Date: Nov. 23, 2017

(54) Wireless Vehicle Data-Enhanced Micro-Navigation Lane Suggestion

(71) Applicant: TOYOTA JIDOSHA KABUSHIKI KAISHA, Toyota-shi (JP)

(72) Inventors: Hongsheng LU, Fremont, CA (US); Gaurav BANSAL, San Jose, CA (US); John KENNEY, Santa Clara, CA (US)

(21) Appl. No.: 15/159,559

(22) Filed: May 19, 2016

(51) Int. Cl. G08G 1/0962; G08G 1/16; G08G 1/097

(52) U.S. Cl. CPC G08G 1/0962; G08G 1/097; G08G 1/166

(57) ABSTRACT

The disclosure includes implementations for providing a micro-navigation suggestion. The method may include receiving a wireless message that includes sensor data that describes a traffic event affecting a route of travel for a vehicle. The wireless message may include a Dedicated Short Range Communication message. The wireless message may include a full-duplex wireless message received during a full-duplex operation mode of a full-duplex coordination system included in the vehicle. The vehicle and the traffic event may be present on a roadway included in the route of travel for the vehicle. The traffic event may be located in a direction where the vehicle is traveling. The method may include analyzing the sensor data included in the wireless message to determine a micro-navigation suggestion for a driver of the vehicle. The method may include providing the micro-navigation suggestion to the driver.

### BACKGROUND

The specification relates to wireless vehicle data-enhanced micro-navigation lane suggestions for connected vehicles.

Vehicles may be manufactured to include navigation systems. The navigation systems may work with a cloud server to determine navigation choices for the user, driving instructions for the navigation choices they select and estimated time of arrivals (“ETA”) during the journey associated with the selected navigation choice.

For example, a user may interact with the in-vehicle navigation system to identify the nearest gas station. The navigation system may communicate the query to the cloud server. The query may include a search term, such as “Gas station” in this example, and global positioning system (“GPS”) data describing the geographic location of the vehicle as determined by the vehicle's GPS unit. The cloud server may search its directory data to identify a set of gas stations that are near the geographic location of the vehicle and navigation instructions associated with each gas station included in the set of gas stations. The set of gas stations in this example are “navigation choices.” The cloud server may wirelessly transmit data to the navigation system describing the navigation choices. A screen of the navigation system may display the navigation choices as options from which the user may select. The user may select one of the gas stations, which is now a “selected navigation choice” or “selected navigation route” based on being selected by the user. The navigation system may provide navigation instructions to assist the user to drive to the gas station as well as an ETA that describes the estimated amount of time it will take the vehicle to reach the selected navigation choice. The ETA may be updated by the cloud server as the vehicle gets closer to the destination.

Accordingly, GPS-based navigation systems are useful for providing the user with information describing a route of travel for a vehicle. However, existing GPS-based navigation systems cannot provide the user with micro-navigation suggestions that may be useful for improving their user experience when traveling the route of travel.

### SUMMARY

Vehicles currently may provide navigation guidance to drivers that are based on GPS data and knowledge about queue lengths along roadways. However, the navigation decisions of drivers can be improved by knowledge of down road events. There are no solutions that currently use Dedicated Short Range Communication-based data (“DSRC-based data”) that describes one or more down road events to improve the navigation decisions of a driver.

Disclosed are implementations for providing one or more micro-navigation suggestions for a driver of a vehicle. A micro-navigation suggestion may include information determined based on DSRC-based data. A DSRC-micro navigation suggestion may include information that may enable a quicker or safer journey (versus journeys that rely solely on a navigation route provided by a conventional GPS-based navigation system) by helping the driver to perform one or more of the following micro-navigation tasks: selecting a best lane of travel; selecting a right time to enter an exit lane; selecting a time to change lanes; selecting a time to overtake a slower moving vehicle; and selecting a time to travel in a fast lane of travel.

DSRC-based data may include any data included in a DSRC message. A DSRC message may include any message transmitted by a DSRC transceiver. One example type of DSRC messages is a basic safety message (“BSM”).

A DSRC-enabled device may include any processor-based computing device that includes a DSRC transceiver and a DSRC receiver. For example, if a vehicle includes a DSRC transceiver and a DSRC receiver, then the vehicle may be described as “DSRC-equipped” or “DSRC-enabled.” Other types of devices may be DSRC-equipped. For example, one or more of the following devices may be DSRC-equipped: a roadside unit (“RSU”); a traffic signal; a traffic light; a vehicle; a smartphone; a smartwatch; a laptop; a tablet computer; a personal computer; and a wearable device.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method implemented by a computer system to provide a micro-navigation suggestion to a driver of a first vehicle, the method including: detecting, by a DSRC-enabled device using a sensor set installed in the DSRC-enabled device, a traffic event, where the sensor set generates sensor data that describes the traffic event; wirelessly transmitting, by a DSRC transmitter installed in the DSRC-enabled device, a DSRC message that includes the sensor data that describes the traffic event; wirelessly receiving, by a DSRC receiver installed in a first vehicle, the DSRC message that includes the sensor data that describes the traffic event, where the first vehicle, the DSRC-enabled device and the traffic event are contemporaneously present on a roadway and the traffic event is located in a direction where the first vehicle is traveling so that the first vehicle is in motion and traveling in the direction of the traffic event on the roadway; analyzing, by a micro-navigation system installed in the first vehicle, the sensor data to determine a micro-navigation suggestion for a driver of the first vehicle; and providing the micro-navigation suggestion to the driver. Other embodiments of this aspect include corresponding computer systems, apparatus, and computer programs recorded on one or more computer storage devices, each configured to perform the actions of the methods.

Implementations may include one or more of the following features. The method where the DSRC-enabled device is a second vehicle that is proximate to the traffic event. The method where the DSRC-enabled device is a roadside unit that is proximate to the traffic event. The method where the sensor set includes a camera and the sensor data includes an image of the traffic event and GPS data that describes an estimate of a location of the traffic event. The method where the DSRC-enabled device is a second vehicle that is traveling in a lane that includes at least a portion of the traffic event, where the second vehicle includes a DSRC-compliant GPS unit that is operable to retrieve GPS data that describes a location of the second vehicle to a lane-level degree of precision and where the sensor data includes information that describes an estimate of the location of the traffic event with the lane-level degree of precision so that the first vehicle that receives the sensor data can determine the estimate of the location of the traffic event with the lane-level degree of precision. The method where the lane-level degree of precision includes being accurate to within plus or minus 1.5 meters. The method where the lane-level degree of precision includes being accurate to within substantially plus or minus 1.5 meters. The method where the micro-navigation suggestion describes a new lane of travel. The method where the micro-navigation suggestion describes a time to enter an exit lane. The method where the micro-navigation suggestion is determined based on the sensor data and roadway data that describes a predetermined navigation route of the first vehicle, where the roadway data is determined by a navigation system included in the first vehicle. The method where the micro-navigation suggestion describes a time to change to a new lane of travel. The method where the micro-navigation suggestion describes a time to change to a fast lane. The method where the micro-navigation suggestion describes a time to overtake a slower moving vehicle. The method where the DSRC-enabled device is the slower moving vehicle so that the slower moving vehicle assists another vehicle to overtake the slower moving vehicle. The method where the DSRC message is a BSM and the sensor data is included in a header of the BSM. The method where the first vehicle is not within DSRC-range of the DSRC-enabled device and the DSRC message is received by the first vehicle as a relay message. The method where the relay message is transmitted by a DSRC-equipped roadside unit that is stationary. The method where the relay message is transmitted by a third vehicle that is DSRC-equipped. Implementations of the described techniques may include hardware, a method or process, or computer software on a computer-accessible medium.

One general aspect includes a system to provide a micro-navigation suggestion to a driver of a first vehicle, the system including: a DSRC-enabled device including a sensor set and a DSRC transmitter, where the sensor set is operable to detect a traffic event and generate sensor data that describes the traffic event and the DSRC transmitter is operable to wirelessly transmit a DSRC message that includes the sensor data; and a vehicle that includes a DSRC receiver, a micro-navigation system and an output device, where the DSRC receive receives the DSRC message that includes the sensor data that describes the traffic event, the micro-navigation system analyzes the sensor data to determine suggestion data that describes a micro-navigation suggestion for a driver of the vehicle and the output device provides an output that describes the micro-navigation suggestion for the driver of the vehicle. Other embodiments of this aspect include corresponding computer systems, apparatus, and computer programs recorded on one or more computer storage devices, each configured to perform the actions of the methods.

One general aspect includes a computer program product including computer code stored on a non-transitory memory that, when executed by a processor, causes the processor to perform steps including: receiving a wireless message that includes sensor data that describes a traffic event affecting a route of travel for a vehicle, where the vehicle and the traffic event are present on a roadway included in the route of travel for the vehicle and the traffic event is located in a direction where the vehicle is traveling so that the vehicle is in motion and traveling in the direction of the traffic event; analyzing the sensor data to determine a micro-navigation suggestion for a driver of the vehicle; and providing the micro-navigation suggestion to the driver. Other embodiments of this aspect include corresponding computer systems, apparatus, and computer programs recorded on one or more computer storage devices, each configured to perform the actions of the methods.

Implementations may include one or more of the following features. The computer program product where the wireless message is a DSRC message. The computer program product where the wireless message is a full-duplex wireless message received during a full-duplex operation mode of a full-duplex coordination system included in the vehicle. The computer program product where providing the micro-navigation suggestion to the driver includes depicting a graphical user interface (“GUI”) on a monitor of the first vehicle that graphically describes the micro-navigation suggestion. The computer program product where providing the micro-navigation suggestion to the driver includes playing audio via a speaker of the first vehicle that audibly describes the micro-navigation suggestion. Implementations of the described techniques may include hardware, a method or process, or computer software on a computer-accessible medium.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an example vehicle including a micro-navigation system according to some implementations.

FIGS. 1B and 1C are a block diagrams illustrating an example operating environment for a plurality of vehicles including the micro-navigation system according to some implementations.

FIG. 1D is a flowchart of an example method for providing a micro-navigation suggestion according to some implementations.

FIG. 2 is a block diagram illustrating an example computer system including a micro-navigation system according to some implementations.

FIG. 3A is a block diagram illustrating an example operating environment for a plurality of vehicles including the micro-navigation system according to some implementations.

FIG. 3B is a block diagram illustrating an example operating environment a plurality of devices including the micro-navigation system according to some implementations.

FIG. 4A is a block diagram illustrating an example of BSM data according to some implementations.

FIG. 4B is a block diagram illustrating an example of BSM data according to some implementations.

FIG. 5 is a diagram illustrating an example of a navigation route provided by a GPS-based navigation system according to some implementations.

### DETAILED DESCRIPTION

Vehicles are increasingly equipped with Dedicated Short Range Communication (“DSRC”). A vehicle equipped with DSRC may be referred to as “DSRC-equipped.” A DSRC-equipped vehicle may include a DSRC antenna and any hardware of software necessary to send and receive DSRC messages, generate DSRC messages and read DSRC messages. For example, a DSRC-equipped vehicle may include any hardware or software necessary to receive a DSRC message, retrieve data included in the DSRC message and read the data included in the DSRC message.

One type of DSRC message is known as a Basic Safety Message (“BSM” if singular or “BSMs” if plural). DSRC-equipped vehicles broadcast a BSM at a regular interval. The interval may be user adjustable.

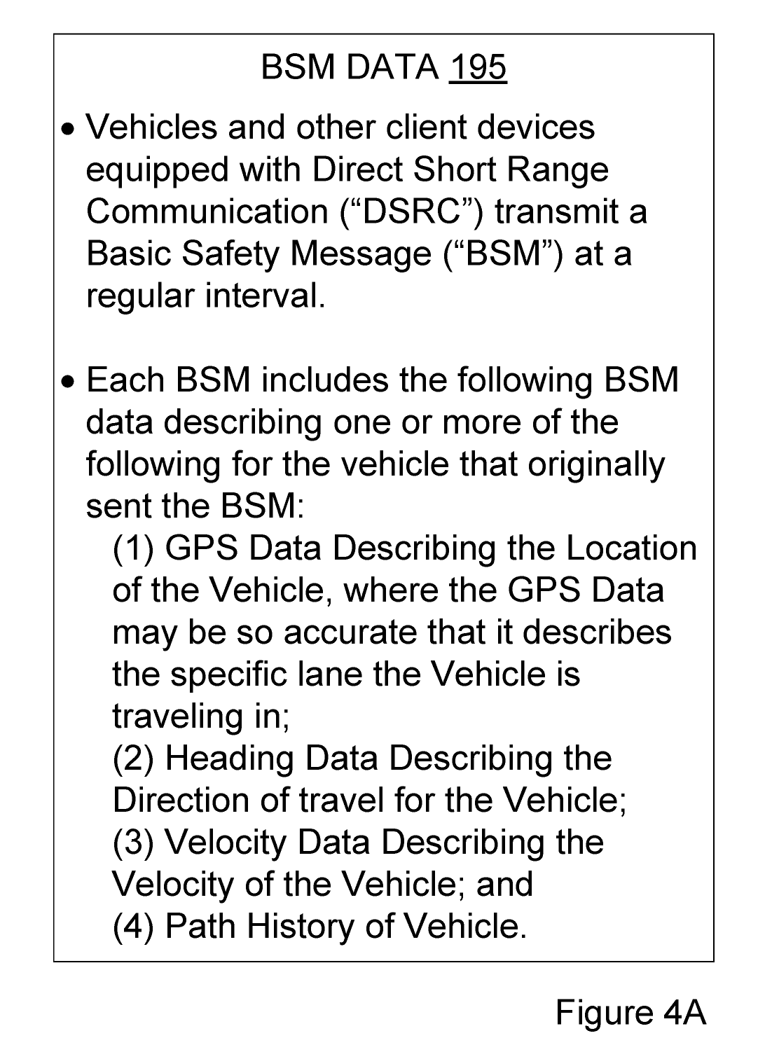

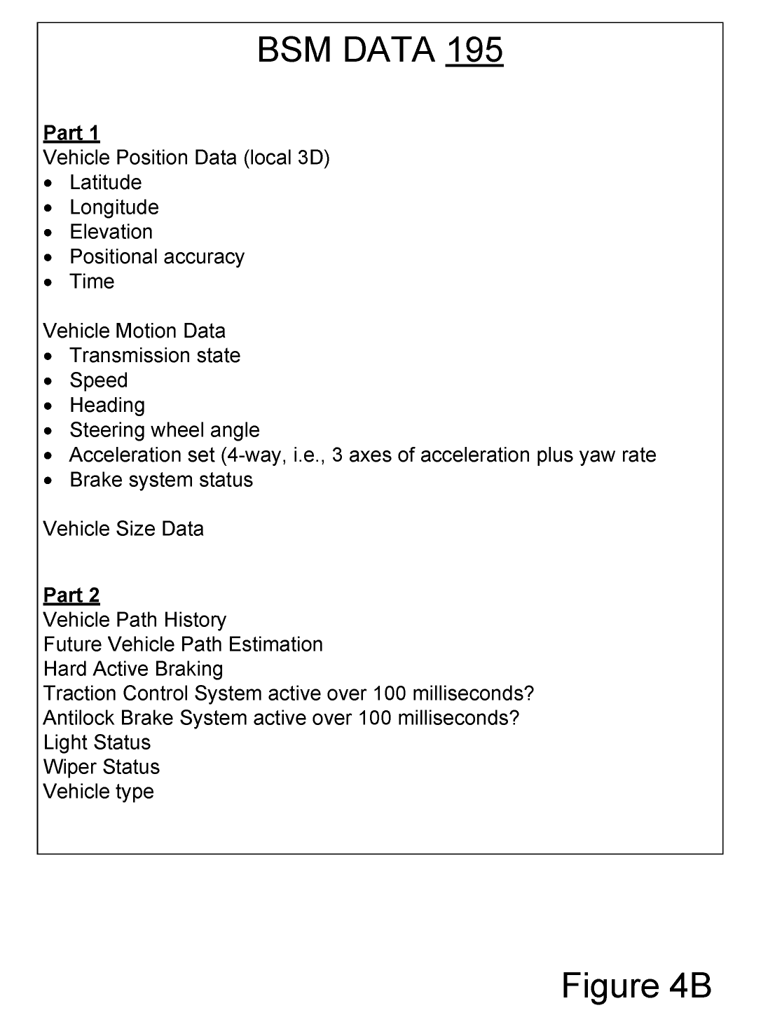

A BSM includes BSM data. The BSM data describes attributes of the vehicle that originally transmitted the BSM message. Vehicles equipped with DSRC may broadcast BSMs at an adjustable rate. In some implementations, the rate may be once every 0.10 seconds. The BSM includes BSM data that describes, among other things, one or more of the following: (1) the path history of the vehicle that transmits the BSM; (2) the speed of the vehicle that transmits the BSM; and (3) the GPS data describing a location of the vehicle that transmits the BSM. FIGS. 4A and 4B depict examples of BSM data according to some implementations. FIGS. 4A and 4B are described below.

In some implementations, DSRC-equipped vehicles may probe other DSRC-equipped vehicles/devices along the roadway for information describing their current and future conditions, including their path history and future path. This information is described as “DSRC probe data.” DSRC probe data may include any data received via a DSRC probe or responsive to a DSRC probe.

A DSRC message may include DSRC-based data. The DSRC-based data may include BSM data or DSRC probe data. In some implementations, the DSRC-based data included in a DSRC message may include BSM data or DSRC probe data received from a plurality of DSRC-equipped vehicles. This BSM data or DSRC probe data may include an identifier of its source and the location of the source or any traffic events described by the BSM data or DSRC probe data.

In some implementations, the DSRC-enabled vehicles will include a DSRC-compliant GPS unit and the BSM data or DSRC probe data will specify which lane a vehicle is traveling in as well as its speed of travel and path history.

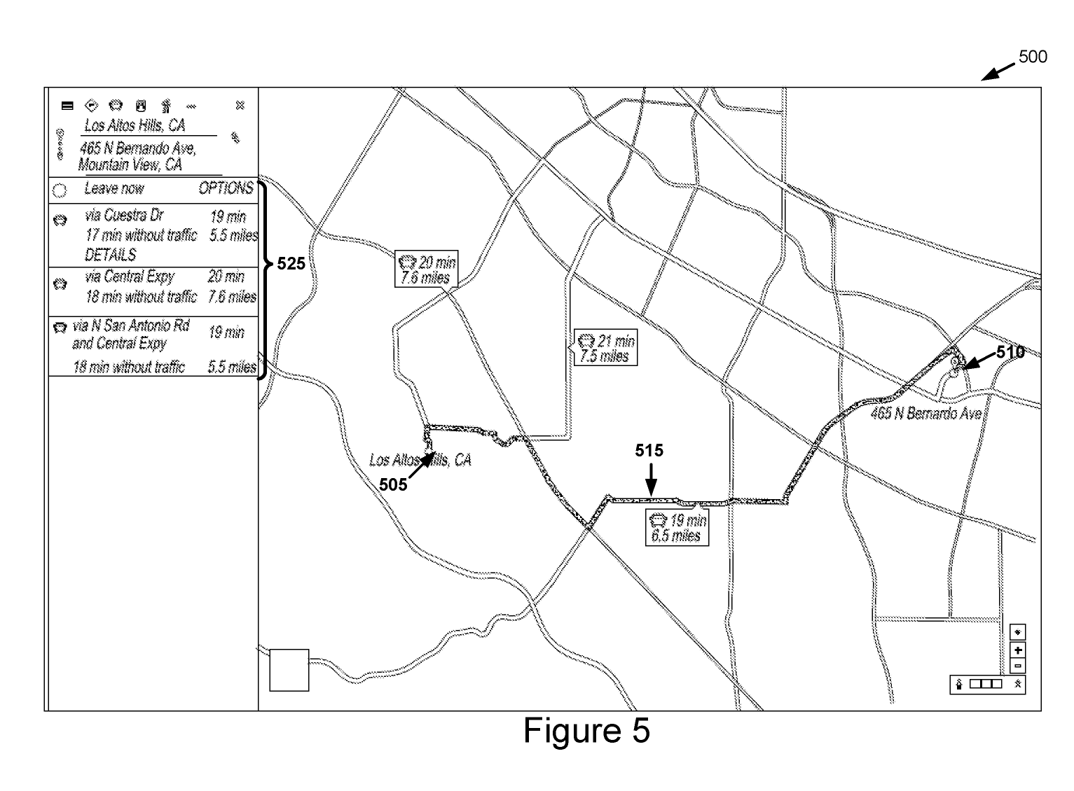

Vehicles are also increasingly manufactured to include GPS-based navigation systems. A GPS-based navigation system may provide navigation routes to a driver that are based on GPS data and knowledge about queue lengths along roadways. An example of a navigation route provided by a GPS-based navigation system is depicted in FIG. 5.

### Micro-Navigation Tasks

Described herein are implementations of a micro-navigation system for providing micro-navigation suggestions to drivers using DSRC-based data. The micro-navigation system described herein may provide a suggestion to assist a driver of a vehicle to complete a micro-navigation task. A micro-navigation task may include one or more of the following: (1) selecting a best lane of travel for a journey of shorter duration; (2) selecting a time to enter an exit lane; (3) selecting a time to change lanes; (4) selecting a time to overtake a slower moving vehicle; and (5) selecting a time to enter a fast lane of travel.

Accordingly, the micro-navigation system may be a vehicle system that is independent of a GPS-based navigation system. For example, the micro-navigation system may provide the suggestion to assist the driver in completing micro-navigation task based on DSRC-based data instead of GPS data.

In some implementations, the micro-navigation system may improve the performance of a GPS-based navigation system. For example, the GPS-based navigation system may provide a route to a driver. The route may include a road selection that would require the vehicle to travel on a roadway whose traffic flow is impaired by a traffic event. The micro-navigation system may provide a suggestion to the GPS-based navigation system that suggests that the impaired roadway not be included in the route or that a different roadway be included in the route instead of the impaired roadway. This suggestion may optimize the route selection of the GPS-based navigation system using DSRC-based data that would not otherwise be available to the GPS-based navigation system. Accordingly, the micro-navigation system described herein may improve the performance of a GPS-based navigation system by assisting the GPS-based navigation system to avoid navigating the driver of a vehicle to a roadway with impaired traffic flow using DSRC-based data.

In some implementations, the micro-navigation system may improve the performance of an autonomous vehicle. For example, the micro-navigation system may be an element of the autonomous vehicle and provide micro-navigation suggestions to the software that controls the operation of the autonomous vehicle. The software that controls the operation of the autonomous vehicle may modify one or more vehicle operations of the autonomous vehicle (e.g., steer the autonomous vehicle to a different lane) based on one or more micro-navigation suggestions received from the micro-navigation system.

### Example Overview

Referring now to FIG. 5. Depicted is a diagram illustrating an example of a navigation route 500 provided by a GPS-based navigation system according to some implementations. To better understand an example benefit of the micro-navigation system, assume that a driver needs to drive from a first location 505 in Los Altos Hills, Calif. to a second location 510 in Menlo Park, Calif. There is a plurality of routes 525 that may be taken from the first location 505 to the second location 510.

The micro-navigation system described herein is not concerned with aiding a user to select from the plurality of routes 525. Instead, assume that the route 515 is selected and the driver is traveling in a vehicle (that includes the micro-navigation system) based on the selection of this route 515. While traveling this route 515, there are many micro-navigation decisions that must be made. These decisions may include which lane to travel in, the right time to enter an exit lane, whether or when to overtake or pass a slower moving vehicle and whether to travel in the fast lane. The micro-navigation system is concerned with helping the driver to make these micro-navigation decisions.

Assume that as the driver's vehicle (i.e., “Vehicle A”) travels the route 515 there are other vehicles (i.e., “Vehicle B,” “Vehicle C,” etc.) that are on the roadway at the same time. Further assume that these other vehicles are located further down the same roadway (or the same route) that Vehicle A is traveling. Vehicles B, C, etc. may be referred to as “down the road vehicles” since they are located down the road relative to Vehicle A. These “down the road vehicles” may observe traffic events that affect the micro-navigation decisions of Vehicle A. The down the road vehicles may transmit one or more DSRC messages (including BSMs) to Vehicle A that assist Vehicle A in making micro-navigation decisions. The micro-navigation system included in Vehicle A may receive these DSRC messages. The micro-navigation system may provide one or more micro-navigation suggestions to the driver of Vehicle A based on the traffic events described by the one or more DSRC messages.

### System Overview

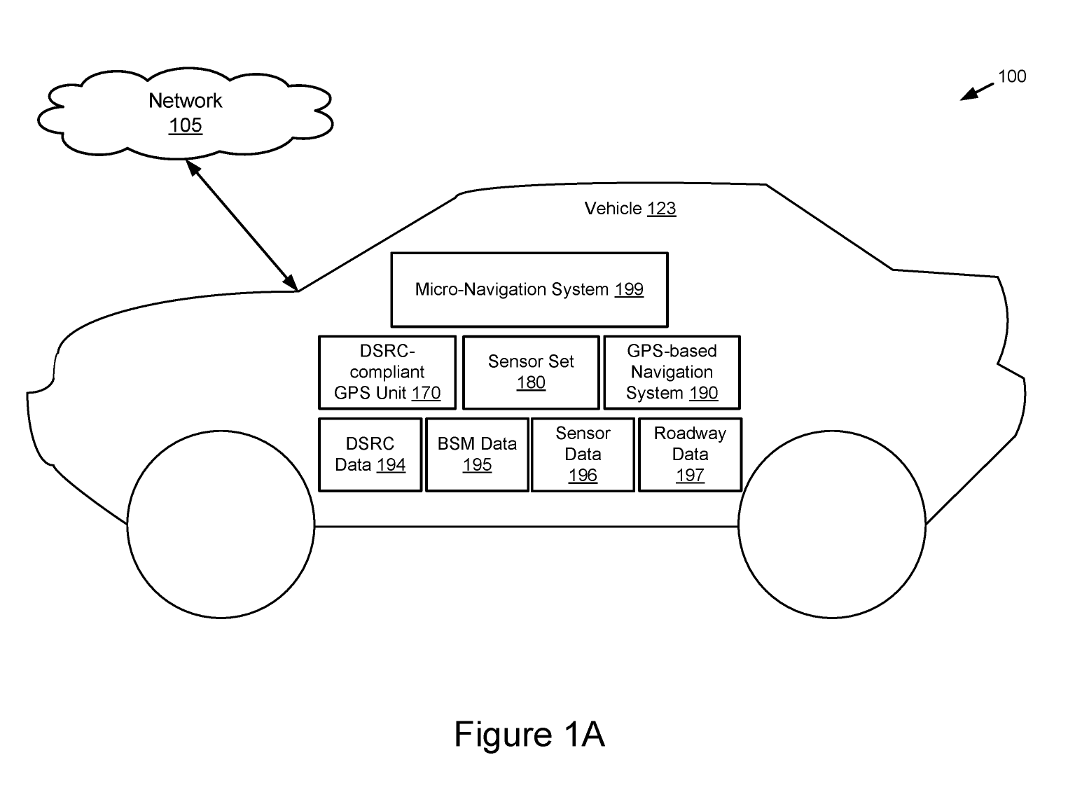

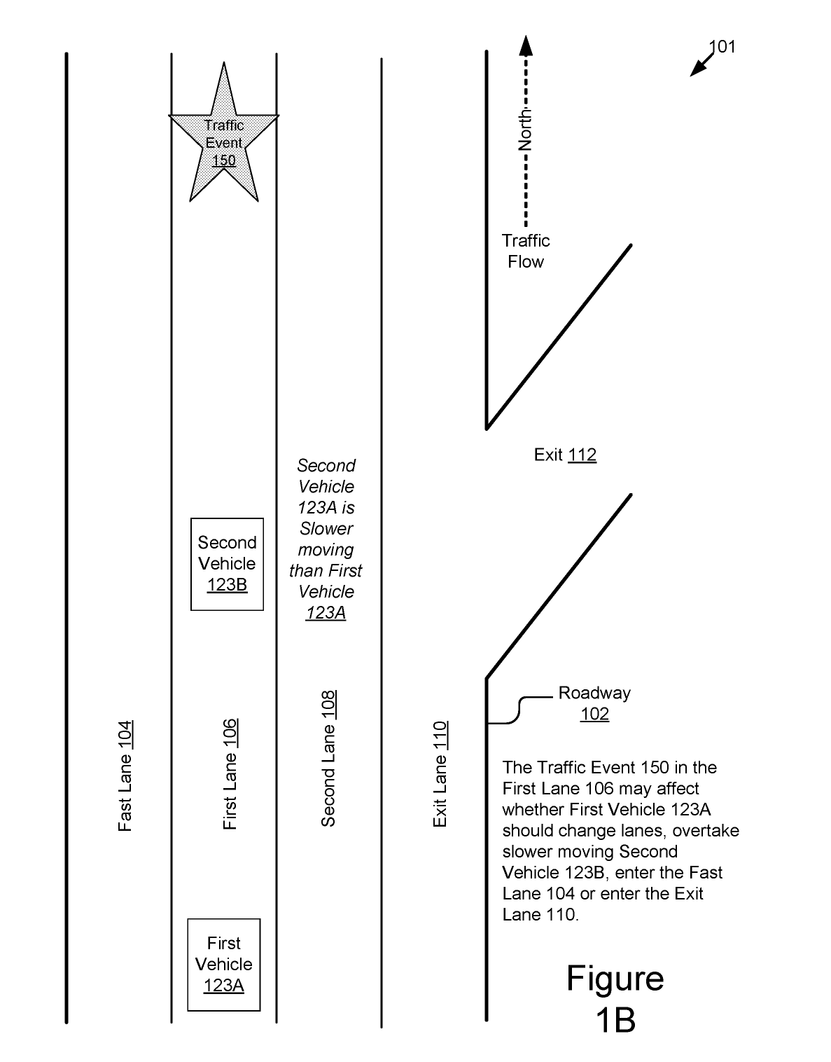

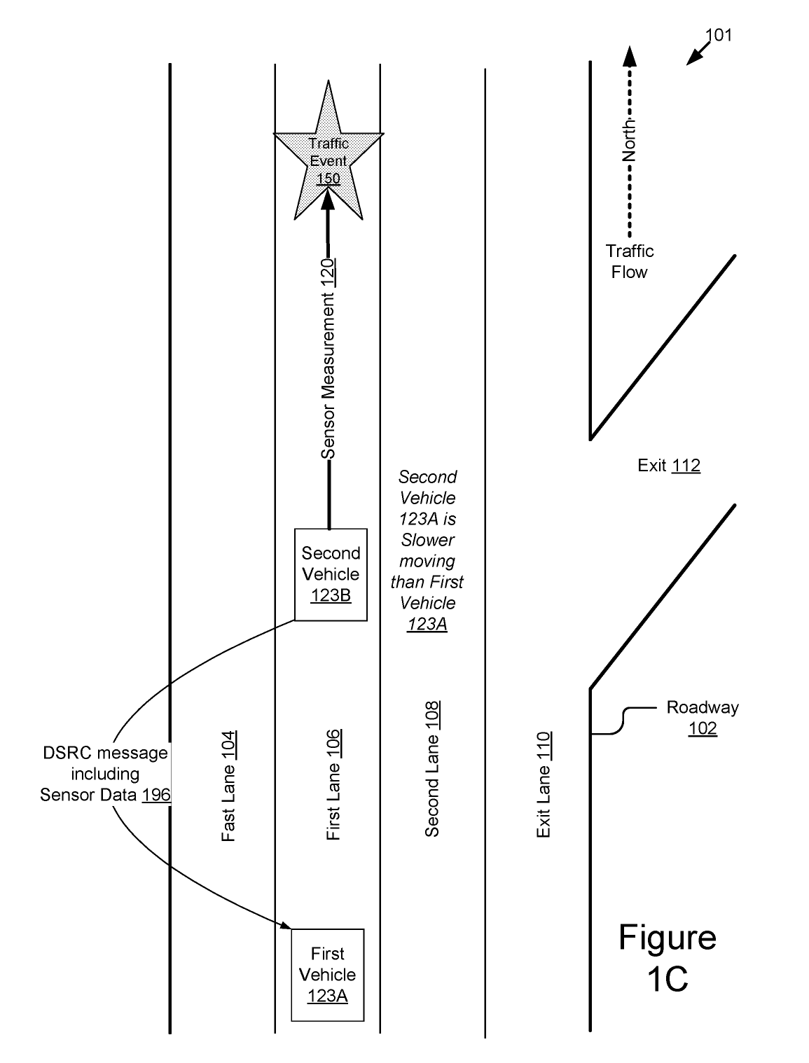

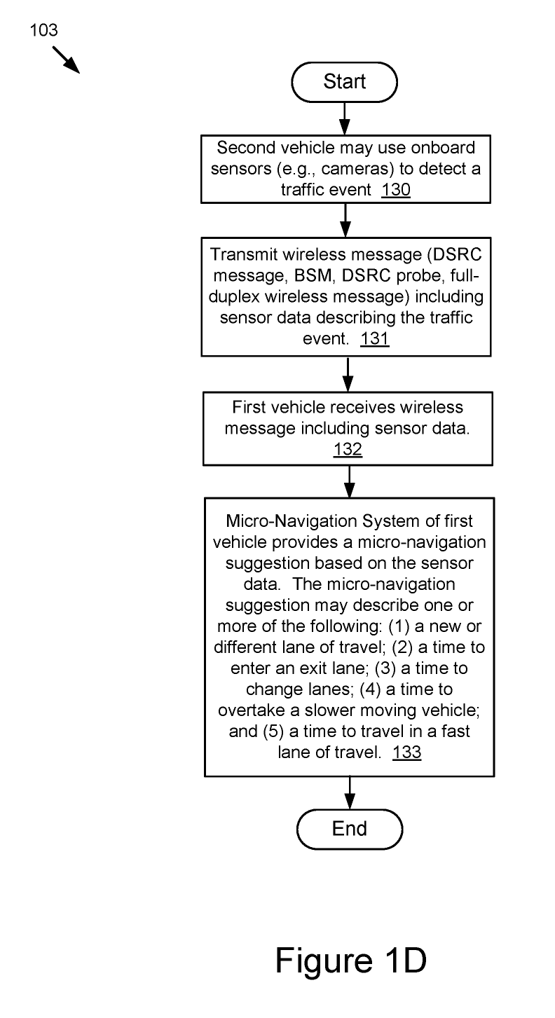

Referring now to FIG. 1A, depicted is a block diagram illustrating an operating environment 100 including an example vehicle 123 including a micro-navigation system 199 according to some implementations.

The vehicle 123 may include a car, a truck, a sports utility vehicle, a bus, a semi-truck, a drone or any other roadway-based conveyance. In some implementations, the vehicle 123 may include an autonomous vehicle or a semi-autonomous vehicle. The vehicle 123 may be a DSRC-enabled vehicle.

The vehicle 123 may include one or more of the following elements: a micro-navigation system 199; a DSRC-compliant GPS unit 170; a sensor set 180; a GPS-based navigation system 190; DSRC data 194; BSM data 195; sensor data 196; and roadway data 197. In some implementations, the BSM data 195 may be an element of the DSRC data 194.

The micro-navigation system 199 may include code and routines that are operable to provide one or more micro-navigation suggestions. The micro-navigation system 199 may provide the micro-navigation suggestion to a driver of the vehicle 123. The micro-navigation system 199 may determine the one or more micro-navigation suggestions based on DSRC-based data. For example, the micro-navigation system 199 may determine the one or more micro-navigation suggestions based on one or more of the DSRC data 194 and the BSM data 195.

Although not depicted in FIG. 1A, in some implementations the vehicle 123 may include a full-duplex coordination system as described in U.S. patent application Ser. No. 14/471,387 filed on Aug. 28, 2014 and entitled “Full-Duplex Coordination System,” the entirety of which is herein incorporated by reference.

In some implementations, the full-duplex coordination system of the vehicle 123 may receive a full-duplex wireless message that includes full-duplex wireless message data that describes a down the road traffic event. For example, the full-duplex coordination system may receive the full duplex wireless message during a full-duplex operation mode of the full-duplex coordination system. The full-duplex coordination system may transmit the full-duplex wireless message data to the micro-navigation system 199. The micro-navigation system 199 may determine a micro-navigation suggestion based on the full-duplex wireless data.

In some implementations, the micro-navigation system 199 may be implemented using hardware including a field-programmable gate array (“FPGA”) or an application-specific integrated circuit (“ASIC”). In some other implementations, the micro-navigation system 199 may be implemented using a combination of hardware and software. The micro-navigation system 199 may be stored in a combination of the devices (e.g., servers or other devices), or in one of the devices.

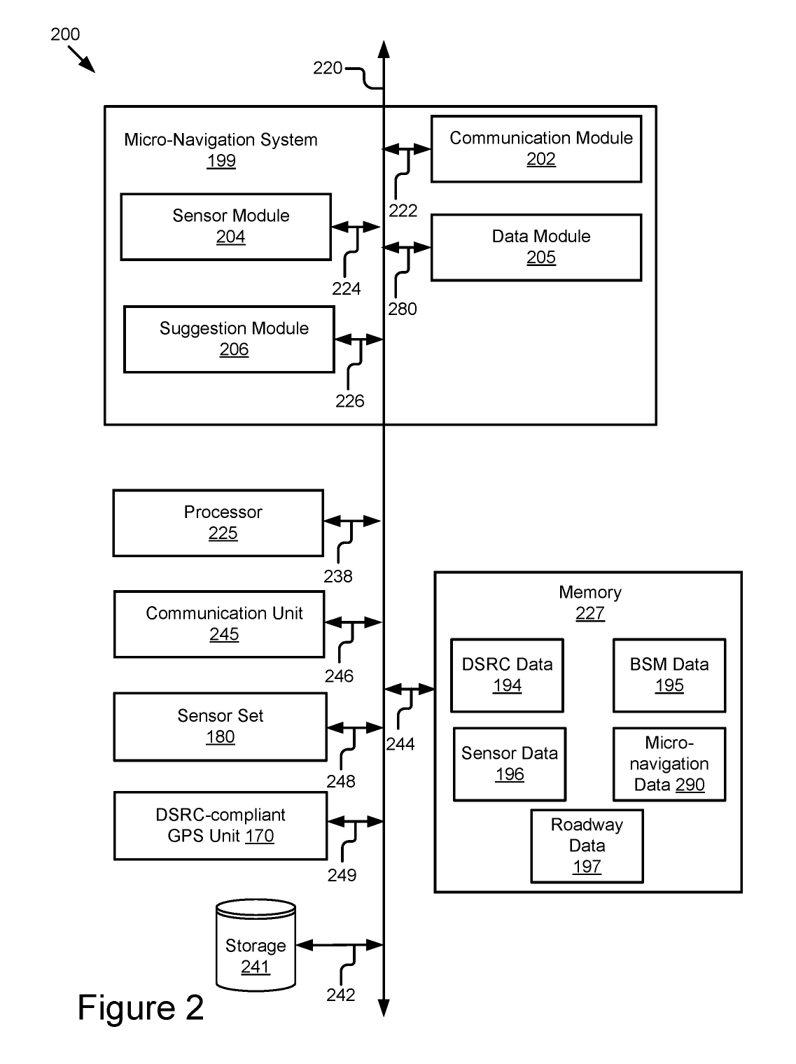

The micro-navigation system 199 is described in more detail below with reference to FIG. 2.

The DSRC-compliant GPS unit 170 may include hardware that wirelessly communicates with a GPS satellite to retrieve GPS data that describes a location of the vehicle 123. In some implementations, a DSRC-compliant GPS unit 170 is operable to provide GPS data that describes the location of the vehicle 123 (or the location of a traffic event observed by a sensor of the vehicle 123, where the sensor is included in the sensor set 180) to a lane-level degree of precision. The DSRC standard requires that GPS data be precise enough to infer if two vehicles (such as vehicle 123 and another vehicle on the same roadway as the vehicle 123) are in the same lane. The DSRC-compliant GPS unit 170 may be operable to identify, monitor and track its two-dimensional position within 1.5 meters of its actual position 68% of the time under an open sky. Since lanes of a roadway are typically no less than 3 meters wide, whenever the two dimensional error of the GPS data is less than 1.5 meters the micro-navigation system 199 may analyze the GPS data provided by the DSRC-compliant GPS unit 170 and determine what lane of the roadway the vehicle 123 is traveling in based on the relative positions of vehicles on the roadway.

For example, referring now to FIG. 1B (and assuming that the first vehicle 123A is the vehicle 123 depicted in FIG. 1A), the micro-navigation system 199 may analyze the GPS data generated by the DSRC-compliant GPS unit 170 and determine that the first vehicle 123A is traveling in a first lane 106 versus a second lane 108 or an exit lane 110 based on the GPS data. By comparison, a GPS unit which is not compliant with the DSRC standard is far less accurate than the DSRC-compliant GPS unit 170 and not capable of reliably providing lane-level accuracy, as is the DSRC-compliant GPS unit 170. For example, a non-DSRC-compliant GPS unit may have an accuracy on the order of 10 meters, which is not sufficiently precise to provide the lane-level degree of precision provided by the DSRC-compliant GPS unit 170. For example, since a lane may be as narrow as 3 meters wide, the DSRC standard may require a DSRC-compliant GPS unit 170 to have an accuracy on the order of 1.5 meters, which is significantly more precise than a non-DSRC-compliant GPS unit as described above.

Referring now to FIG. 1A, in some implementations the GPS data retrieved by the DSRC-compliant GPS unit 170 may be an element of the roadway data 197.

The sensor set 180 may include one or more sensors that are operable to measure the physical environment outside of the vehicle 123. For example, the sensor set 180 may record one or more physical characteristics of the physical environment that is proximate to the vehicle 123. The sensor set 180 may include one or more of the following sensors: a camera; a LIDAR sensor; a laser altimeter; a navigation sensor (e.g., a global positioning system (GPS) sensor); an infrared detector; a motion detector; a thermostat; a sound detector, a carbon monoxide sensor; a carbon dioxide sensor; an oxygen sensor; a mass air flow sensor; an engine coolant temperature sensor; a throttle position sensor; a crank shaft position sensor; an automobile engine sensor; a valve timer; an air-fuel ratio meter; a blind spot meter; a curb feeler; a defect detector; a Hall effect sensor, a manifold absolute pressure sensor; a parking sensor; a radar gun; a speedometer; a speed sensor; a tire-pressure monitoring sensor; a torque sensor; a transmission fluid temperature sensor; a turbine speed sensor (TSS); a variable reluctance sensor; a vehicle speed sensor (VSS); a water sensor; a wheel speed sensor; and any other type of automotive sensor.

The sensor set 180 may be operable to record sensor data 196 that describes a traffic event that is within the physical environment that is external to the vehicle 123.

The GPS-based navigation system 190 may include a conventional vehicle navigation system. In some implementations, the GPS-based navigation system 190 may be communicatively coupled to the DSRC-compliant GPS unit 170 so that the GPS-based navigation system 190 may determine a navigation route for the vehicle 123 based on GPS data having lane level precision.

As described below with reference to FIG. 2, in some implementations the micro-navigation system 199 may include a communication unit 245. In some implementations, the communication unit 245 may include, for example, one or more of the following: a DSRC receiver; a DSRC transceiver; a full-duplex coordination system; a mobile network antenna; a Wi-Fi™ antenna; and any other hardware or software that is operable to provide wireless communication capabilities to the micro-navigation system 199.

The DSRC data 194 may include any data that is included in a DSRC message, a BSM or a DSRC probe. The DSRC data 194 may be received from another DSRC-enabled device or generated by the vehicle 123. In some implementations, DSRC data 194 may include one or more of the following: the sensor data 196; the BSM data 195; the roadway data 197; GPS data included in the roadway data 197; and any other data that may be stored in a non-transitory memory of the vehicle 123 or the micro-navigation system 199.

In some implementations the DSRC data 194 may include sensor data 196 that describes a traffic event and GPS data that describes a location of the traffic event or a lane of a roadway where the traffic event is located. The micro-navigation system 199 may transmit the DSRC data 194 to another DSRC-enabled device via the communication unit 245 described below with reference to FIG. 2.

In some implementations, the DSRC data 194 may include sensor data 196 or GPS data that is received from another DSRC-enabled device. The micro-navigation system 199 may analyze the DSRC data 194 and identify the presence of a traffic event included in a route provided by the GPS-based navigation system 190. The micro-navigation system 199 may further analyze the DSRC data 194 to identify a location of the traffic event or which lane (or lanes) the traffic event is located in. In some implementations, the DSRC data 194 may also identify one or more lanes that are not affected by the traffic event. In some implementations, the one or more lanes that are not affected by the traffic event may be included as candidates for suggested lanes of travel by the vehicle 123.

The roadway data 197 may describe, among other things, a current navigation route of the vehicle 123. For example, as described above for FIG. 5, the vehicle 123 may be traveling on a route that goes from Los Altos Hills, Calif. to Menlo Park, Calif. The roadway data 197 may identify this current navigation route of the vehicle 123 and, optionally, which lane the vehicle 123 is currently traveling in based on the GPS data provided by the DSRC-compliant GPS unit 170.

In some implementations, the micro-navigation system 199 may determine based on one or more of the roadway data 197 and the DSRC data 194 that the vehicle 123 is currently traveling in the same lane as the traffic event described by the sensor data 196 included in the DSRC data 194. The micro-navigation system 199 may determine based on one or more of the DSRC data 194 and the roadway data 197 that the traffic event may be unsafe for the vehicle 123 or may otherwise impede the journey of the vehicle 123 (e.g., a slower journey, a less enjoyable journey, etc).

In some implementations, the micro-navigation system 199 may provide a micro-navigation suggestion to a driver of the vehicle 123 based on one or more of the DSRC data 194 and the roadway data 197. For example, the micro-navigation system 199 may provide a micro-navigation suggestion to the driver that indicates that the driver should change to a new or different lane of travel. The new or different lane of travel may be determined based at least in part on the DSRC data 194 or the roadway data 197. For example, the DSRC data 194 may include sensor data 196 that describes which lanes are not affected by the traffic event. Similarly, the roadway data 197 may describe the roadway, how many lanes are included in the roadway, an identity of the different lanes (a first lane, a second lane, a fast lane, an exit lane, a breakdown lane, etc.) and the function of the different lanes (e.g., a fast lane, an exit lane, a breakdown lane, etc.).

In some implementations, the micro-navigation suggestion provided by the micro-navigation system 199 may include information that is presented to the driver and describes the traffic event as being present down the road in the present lane of travel. For example, the micro-navigation system 199 provides a GUI or audio description that may be presented to the driver that describes the traffic event (e.g., a traffic accident, a traffic stop, a DUI check, roadway debris, an object on the roadway, etc.).

In some implementations, the micro-navigation suggestion provided by the micro-navigation system 199 may also include that is presented to the driver and identifies a suggested different lane of travel. For example, the micro-navigation system 199 provides a GUI or audio description that may be presented to the driver that describes a suggested different lane of travel that is selected by the micro-navigation system 199 from the candidate lanes of travel described by one or more of the DSRC data 194 and the roadway data 197.

In some implementations, the micro-navigation suggestion provided by the micro-navigation system 199 may also specify a time the driver should navigate to the suggested different lane of travel. The time may be based in part on the traffic that is proximate to the vehicle 123 as described by the sensor data 196 generated by the sensor set 180 so that the vehicle 123 does collide with another vehicle or roadway object when navigating to a different lane of travel.

The BSM data 195 may include data that is included in a BSM. The BSM data 195 may be received from another DSRC-enabled device or generated by the vehicle 123. The BSM data 195 are described in more detail below with reference to FIGS. 4A and 4B.

The sensor data 196 may include data that describes a physical environment of a DSRC-enabled device such as the vehicle 123 or some other DSRC-enabled device. The sensor data 196 may be generated by the sensor set 180. The sensor data 196 may be received via a DSRC message, a BSM, a DSRC probe or some other wireless message such as a full-duplex wireless message. The sensor data 196 may include a combination of sensor data 196 that is sourced from the sensor set 180 and data included in a wireless message that is received via the communication unit 245 of the vehicle 123.

The roadway data 197 may include data that describes a roadway that is being traveled by the vehicle 123 or is included in a route that is being traveled by the vehicle 123. The roadway data 197 may include data that describes a route being traveled by the vehicle 123. The route may be generated by the GPS-based navigation system 190. The roadway data 197 may include GPS data for the vehicle 123 that is generated by the DSRC-compliant GPS unit 170. The roadway data 197 may describe which lane the vehicle 123 is currently traveling in. The roadway data 197 may describe one or more candidate lanes of travel for the vehicle 123 that are present in the current roadway being traveled in by the vehicle 123.

The vehicle 123 may be communicatively coupled to the network 105. The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some implementations, the network 105 may include a peer-to-peer network. The network 105 may also be coupled to or may include portions of a telecommunications network for sending data in a variety of different communication protocols. In some implementations, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, etc. The network 105 may also include a mobile data network that may include third-generation (3G), fourth-generation (4G), long-term evolution (LTE), Voice-over-LTE (“VoLTE”) or any other mobile data network or combination of mobile data networks. Further, the network 105 may include one or more IEEE 802.11 wireless networks.

In some implementations, the network 105 may include one or more communication channels shared among the vehicle 123 and one or more other wireless communication devices (e.g., other vehicles 123, an RSU, etc.). The communication channel may include DSRC, full-duplex wireless communication or any other wireless communication protocol. For example, the network 105 may be used to transmit a DSRC message to the vehicle 123.

Referring now to FIG. 1B, depicted is a block diagram illustrating an example operating environment 101 for a plurality of vehicles 123A, 123B including a micro-navigation system, according to some implementations.

The operating environment 101 may include a roadway 102. The roadway 102 may include a first vehicle 123A and a second vehicle 123B traveling on the roadway 102. The first vehicle 123A and the second vehicle 123B may include similar elements as the vehicle 123 described above with reference to FIG. 1A, and so, that description will not be repeated here.

The roadway 102 may include a traffic flowing in the north-bound direction. The roadway may include one or more of the following elements: a fast lane 104; a first lane 106; a second lane 108; an exit lane 110; an exit 112; and a traffic event 150 present in the first lane 106.

The traffic event 150 may include any event that may affect travel in one or more lanes of the roadway 102 or the exit 112 of the roadway 102. For example, the traffic event 150 may include one or more of the following: a traffic accident; a traffic stop; a traffic checkpoint; roadway debris; an animal; a pothole; an ice patch; a pool of water; a flooded portion of the roadway 102; a malfunctioning traffic signal; a vehicle moving slower than other vehicles on the roadway 102; a vehicle moving slower than the speed limit; a vehicle moving slower than the minimum speed for the roadway 102; a firetruck, police vehicle, ambulance, snowplow, trash truck or other emergency vehicle with warning lights flashing; a broke down vehicle; or any other obstruction or object that may affect the flow of traffic in the roadway 102 or a portion of the roadway 102.

The fast lane 104 may include a lane of the roadway 102 for use by traffic that is moving faster than the rest. The fast lane 104 may include a reserved lane of traffic. For example, the fast lane 104 may include a lane reserved for vehicles having a predetermined fuel efficiency or a plurality of passengers (e.g., carpooling). For example, the fast lane 104 may be a high-occupancy vehicle lane (e.g., an “HOV lane,” “carpool lane,” “diamond lane,” “express lane,” etc.). In some implementations, the fast lane 104 may be reserved for busses or vans.

The first lane 106 and the second lane 108 may include regular lanes of travel for the roadway 102.

The exit lane 110 may include a lane of travel that is intended for vehicles that are taking the exit 112. The exit 112 may include a portion of the roadway 102 that is designated for leaving the roadway 102. The exit 112 may lead to an on-ramp or an off-ramp.

Assume for example in FIG. 1B that the second vehicle 123B is traveling at a slower speed than the first vehicle 123A. The traffic event 150 in the first lane 106 may affect whether the first vehicle 123A will change lanes, overtake the slower moving second vehicle 123B, enter the fast lane 104 or enter the exit lane 110. This example is continued below with the discussion of FIG. 1C.

Referring now to FIG. 1C, depicted is the same operating environment 101 described above with reference to FIG. 1B. In FIG. 1C, the second vehicle 123 may include a micro-navigation system 199. The micro-navigation system 199 may include a sensor set 180 that detect the traffic event 150 via one or more sensor measurements 120. The micro-navigation system 199 of the second vehicle 123B may transmit a DSRC message including sensor data 196 that describes the traffic event 150 based on the one or more sensor measurements 120.

In some implementations, the DSRC message may also include GPS data describing a location of the second vehicle 123B or an approximate location of the traffic event 150. For example, second vehicle 123 may include a DSRC-compliant GPS unit 170 that provides GPS data describing a location of the second vehicle. The sensor set 180 of the second vehicle 123 may include a LIDAR sensor or some other range finder that provides sensor data 196 describing how far the traffic event 150 is from the second vehicle 123B (i.e., range information”). The micro-navigation system 199 of the second vehicle 123 may determine the location of the traffic event 150 based on the GPS data for the second vehicle 123B and the range information for the traffic event 150. In this way the DSRC message transmitted to the first vehicle 123A may include GPS data that describes the location of the traffic event 150 or the location of the second vehicle 123B. The GPS data may be an element of the sensor data 196.

The first vehicle 123A may include a micro-navigation system 199 that receives the DSRC message and determines a micro-navigation suggestion for a driver of the first vehicle 123 based at least in part on the sensor data 196 included in the DSRC message. For example, the micro-navigation system of the first vehicle 123 may determine that the first vehicle 123 should navigation to the fast lane 104 or the second lane 108 to pass the second vehicle 123B and avoid or minimize the effect of the traffic event 150.

In some implementations, the DSRC message may be a BSM that includes the BSM data 195 included in a BSM (e.g., GPS location of the second vehicle 123B, heading of the second vehicle 123B, velocity of the second vehicle 123B, path history of the second vehicle 123B). The first vehicle 123A may aggregate this BSM data 195 from many vehicles similar to the second vehicle 123B. The micro-navigation system 199 may analyze the aggregated BSM data 195. Analysis of the aggregated BSM data 195 may reveal the likelihood of some traffic event 150 and the micro-navigation system 199 of the first vehicle 123A may make a micro-navigation suggestion based on this likelihood. The BSM data 195 is described in more detail below with reference to FIGS. 4A and 4B according to some implementations.

In some implementations, the micro-navigation system 199 of the first vehicle 123A may determine a micro-navigation suggestion based on a combination of both DSRC data 194 including sensor data 196 describing one or more traffic events 150 detected by upstream vehicles relative to the first vehicle 123A (such as the second vehicle 123B) and BSM data 195 as described in the preceding paragraph and with reference to FIGS. 4A and 4B.

FIG. 1D is a flowchart of an example method 103 for providing a micro-navigation suggestion, according to some implementations.

At step 130, a second vehicle may use one or more onboard sensors to detect a traffic event.

At step 131, a communication unit of the second vehicle may transmit a wireless message that includes sensor data describing the traffic event. The wireless message may include one or more of the following: a DSRC message; a BSM; a DSRC probe; and a full duplex wireless message. The sensor data may include GPS data describing one or more of a location of the second vehicle and a location of the traffic event.

At step 132, a first vehicle may receive the wireless message including the sensor data.

At step 133, a micro-navigation system of the first vehicle may determine a micro-navigation suggestion for a driver of the first vehicle based on the sensor data included in the wireless message. The micro-navigation system may provide the micro-navigation suggestion to the driver of the first vehicle.

Referring now to FIG. 2, depicted is a block diagram illustrating an example computer system 200 including the micro-navigation system 199 according to some implementations.

In some implementations, the computer system 200 may include a special-purpose computer system that is programmed to perform one or more steps of the method 103 described above with reference to FIG. 1D.

In some implementations, the computer system 200 may include an onboard vehicle computer of the vehicle 123. In some implementations, the computer system 200 may include an engine control unit, head unit or some other processor-based computing device of the vehicle 123.

The computer system 200 may include one or more of the following elements according to some examples: the micro-navigation system 199; a processor 225; a communication unit 245; the sensor set 180; the DSRC-compliant GPS unit 170; a storage 241; and a memory 227. The components of the computer system 200 are communicatively coupled by a bus 220.

In the illustrated implementation, the processor 225 is communicatively coupled to the bus 220 via a signal line 238. The memory 227 is communicatively coupled to the bus 220 via a signal line 244. The communication unit 245 is communicatively coupled to the bus 220 via a signal line 246. The sensor set 180 is communicatively coupled to the bus 220 via a signal line 248. A DSRC-compliant GPS unit 170 is communicatively coupled to the bus 220 via a signal line 249. The storage 241 is communicatively coupled to the bus 220 via a signal line 242.

The sensor set 180 and the DSRC-compliant GPS unit 170 were described above with reference to FIG. 1A, and so, those descriptions will not be repeated here.

The processor 225 includes an arithmetic logic unit, a microprocessor, a general purpose controller, or some other processor array to perform computations and provide electronic display signals to a display device. The processor 225 is coupled to the bus 220 for communication with the other components via signal line 238. The processor 225 processes data signals and may include various computing architectures including a complex instruction set computer (CISC) architecture, a reduced instruction set computer (RISC) architecture, or an architecture implementing a combination of instruction sets. Although FIG. 2 includes a single processor 225, multiple processors may be included. Other processors, operating systems, sensors, displays, and physical configurations may be possible.

The memory 227 stores instructions or data that may be executed by the processor 225. The memory 227 is coupled to the bus 220 for communication with the other components via signal line 244. The instructions or data may include code for performing the techniques described herein. The memory 227 may be a dynamic random access memory (DRAM) device, a static random access memory (SRAM) device, flash memory, or some other memory device. In some implementations, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

As illustrated in FIG. 2, the memory 227 stores one or more of the following elements: the DSRC data 194; the BSM data 195; the sensor data 196; the micro-navigation data 290; and the roadway data 197. These elements of the memory 227 are described above with reference to FIG. 1A-1D, and so, these descriptions will not be repeated here: the DSRC data 194; the BSM data 195; the sensor data 196; and the roadway data 197. Although not pictured in FIG. 4A, the memory 227 may include GPS data as described above. The GPS data may be an element of the sensor data 196 or the roadway data 197.

The micro-navigation data 290 includes data that describes one or more micro-navigation suggestions determined by the micro-navigation system 199. The micro-navigation data 290 may include graphical data for depicting the micro-navigation suggestion. The micro-navigation data 290 may include audio data for reproducing an audio signal that is operable to cause a speaker of a vehicle 123 to reproduce audio that describes the micro-navigation suggestion for a driver of the vehicle 123.

The communication unit 245 transmits and receives data to and from a network 105 or to another communication channel. The network 105 or the communication channel may include one or more of the following: a DSRC communication channel; a Wi-Fi™ network; a mobile network (3G, 4G, LTE, 5G); a full-duplex communication channel; or any other wireless network or communication channel. For example, the communication unit 245 may include a DSRC transceiver, a DSRC receiver and other hardware or software necessary to make the computer system 200 a DSRC-enabled device.

The communication unit 245 is coupled to the bus 220 via signal line 246. In some implementations, the communication unit 245 includes a port for direct physical connection to the network 105 or to another communication channel. For example, the communication unit 245 includes a USB, SD, CAT-5, or similar port for wired communication with the network 105. In some implementations, the communication unit 245 includes a wireless transceiver for exchanging data with the network 105 or other communication channels using one or more wireless communication methods, including: IEEE 802.11; IEEE 802.16, BLUETOOTH®; EN ISO 14906:2004 Electronic Fee Collection—Application interface EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); the communication method described in U.S. patent application Ser. No. 14/471,387 filed on Aug. 28, 2014 and entitled “Full-Duplex Coordination System”; or another suitable wireless communication method.

In some implementations, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some implementations, the communication unit 245 includes a wired port and a wireless transceiver. The communication unit 245 also provides other conventional connections to the network 105 for distribution of files or media objects using standard network protocols including TCP/IP, HTTP, HTTPS, and SMTP, millimeter wave, DSRC, etc.

The storage 241 can be a non-transitory storage medium that stores data for providing the functionality described herein. The storage 241 may be a dynamic random access memory (DRAM) device, a static random access memory (SRAM) device, flash memory, or some other memory devices. In some implementations, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. The storage 241 is communicatively coupled to the bus 220 via signal line 242.

In the illustrated implementation shown in FIG. 2, the micro-navigation system 199 includes a communication module 202, a sensor module 204, a data module 205 and a suggestion module 206. These components of the micro-navigation system 199 are communicatively coupled to each other via the bus 220. In some implementations, components of the micro-navigation system 199 can be stored in a single server or device. In some other implementations, components of the micro-navigation system 199 can be distributed and stored across multiple servers or devices.

The communication module 202 can be software including routines for handling communications between the micro-navigation system 199 and other components of the computer system 200. In some implementations, the communication module 202 can be a set of instructions executable by the processor 225 to provide the functionality described below for handling communications between the micro-navigation system 199 and other components of the computer system 200. In some implementations, the communication module 202 can be stored in the memory 227 of the computer system 200 and can be accessible and executable by the processor 225. The communication module 202 may be adapted for cooperation and communication with the processor 225 and other components of the computer system 200 via signal line 222.

The communication module 202 sends and receives data, via the communication unit 245, to and from one or more elements of the computer system 200 or the network 105. For example, the communication module 202 receives, via the communication unit 245, one or more of the following: the DSRC data 194; the BSM data 195; the sensor data 196; and the roadway data 197.

In some implementations, the communication module 202 receives data from components of the micro-navigation system 199 and stores the data in one or more of the storage 241 and the memory 227. For example, the communication module 202 receives the micro-navigation data 290 from the suggestion module 206 and stores the micro-navigation data 290 in the memory 227.

In some implementations, the communication module 202 may handle communications between components of the micro-navigation system 199. For example, the communications module 202 may handle communications between the sensor module 204 and the data module 205.

The sensor module 204 can be software including routines for using one or more of the sensors included in the sensor set 180 to generate the sensor data 196. For example, the sensor module 204 may include code and routines that, when executed by the processor 225, cause the processor 225 to operate one or more of the sensors included in the sensor set 180 to record measurements of the physical environment proximate to a vehicle and identify a traffic event that is present on a roadway, which lanes of the roadway are affected by the traffic event and which lanes of the roadway are not affected by the traffic event. The sensor module 204 may generate sensor data 196 describing the measurements of the sensor set 180. The sensor module 204 may cause the sensor data 196 to be stored in the memory 227. In some implementations, the sensor module 204 can be stored in the memory 227 of the computer system 200 and can be accessible and executable by the processor 225. The sensor module 204 may be adapted for cooperation and communication with the processor 225 and other components of the computer system 200 via signal line 224.

The data module 205 can be software including routines for analyzing one or more wireless messages received via the communication unit 245 and identifying one or more of the following wireless message data present in the one or more wireless messages: DSRC data 194; BSM data 195; sensor data 196 and roadway data 197. The data module 205 may retrieve the wireless message data from the wireless message and cause the wireless message data to be stored in the memory 227. In some implementations, the data module 205 can be stored in the memory 227 of the computer system 200 and can be accessible and executable by the processor 225. The data module 205 may be adapted for cooperation and communication with the processor 225 and other components of the computer system 200 via signal line 280.

In some implementations, the data module 205 may organize the wireless message data based on which device transmitted the wireless message that included the wireless message data. In this way, the data module 205 may track the source of the wireless message data. In some implementations, an individual wireless message may include wireless message data from one or more devices (e.g., a relay message) and the sensor module 204 may identify the source of each portion of wireless message data.

In some implementations, the data module 205 may index the wireless message data so that it may be retrieved and analyzed by the suggestion module 206.

In some implementations, the data module 205 may discard any wireless message data that does not describe a traffic event. This functionality may beneficially save space on the memory 227 or expedite the operation of the micro-navigation system 199 to provide real-time or substantially real-time analysis of the wireless message data to provide the micro-navigation data 290 in real-time or substantially real-time relative to receipt of the wireless message data.

In some implementations, the data module 205 may receive sensor data 196 from the sensor module 204. The data module 205 may build a wireless message that includes the sensor data 196. The communication unit 245 may transmit the wireless message that includes the sensor data 196. For example, the data module 205 may build a DSRC message that may include the sensor data 196 (including, in some implementations, location data received via the DSRC-compliant GPS unit 170) as DSRC data 194 encoded in the DSRC message.

In some implementations, the data module 205 may periodically analyze the data stored on the memory 227 to identify the presence of a traffic event. For example, the GPS data may indicate that vehicles at a particular location have a pattern of behavior that indicates a traffic event. The behavior may include, for example, slowing down, speeding up, hard breaking, stopping, crossing a lane of opposing traffic, changing lanes, turning around, modifying their route, swerving, hydroplaning, etc.

In some implementations, the data module 205 may determine the type of the traffic event and the implications of the traffic event. For example, the traffic event may be indicated by a presence of a pattern among a plurality of vehicles that are at the same location on the roadway. For example, the GPS data may indicate that vehicles at a particular location on the roadway have a pattern of hydroplaning, which would indicate the presence of a road or lane flooded with a liquid.

The suggestion module 206 can be software including routines for generating the micro-navigation data 290 and providing a micro-navigation suggestion as described above. In some implementations, the suggestion module 206 can be stored in the memory 227 of the computer system 200 and can be accessible and executable by the processor 225. The suggestion module 206 may be adapted for cooperation and communication with the processor 225 and other components of the computer system 200 via signal line 226.

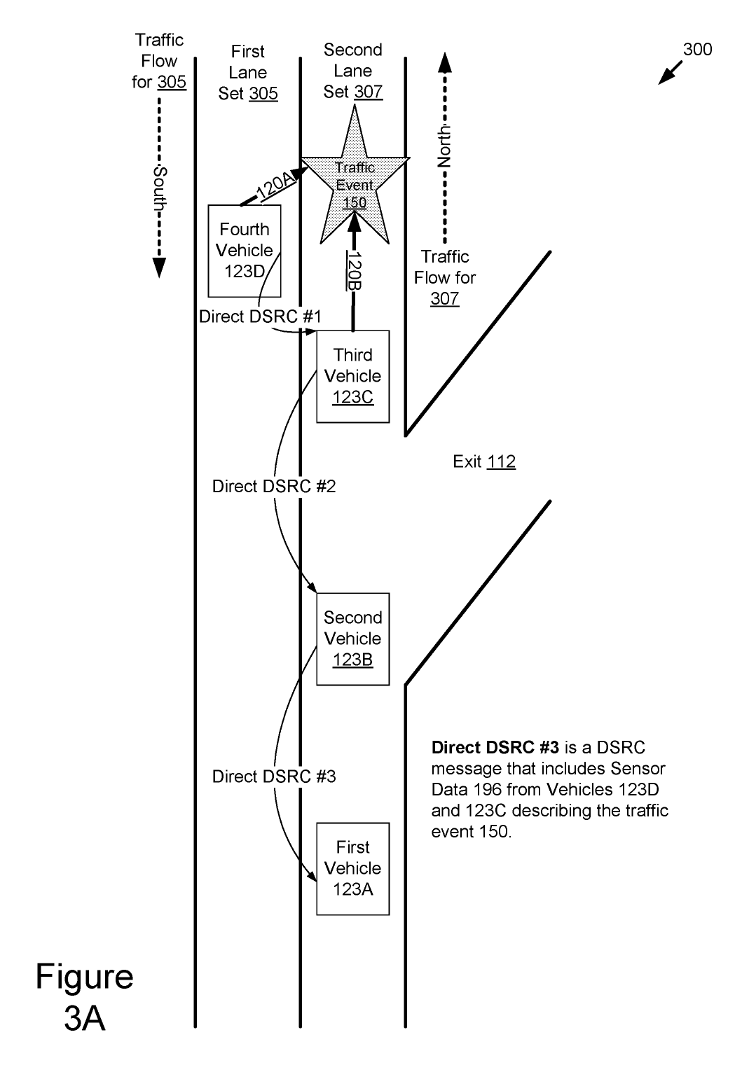

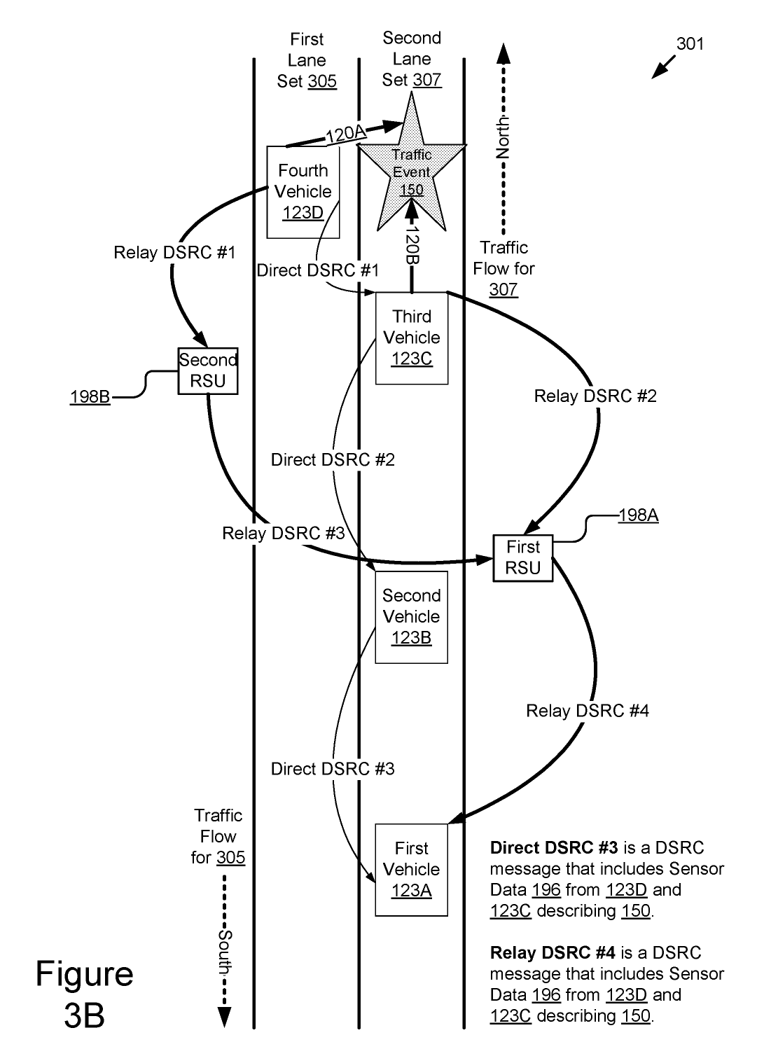

FIG. 3A is a block diagram illustrating an example operating environment 300 for a plurality of vehicles 123 including a micro-navigation system according to some implementations.

The operating environment 300 may include a roadway including a first lane set 305 and a second lane set 307. Each lane set may include one or more lanes of travel. For example, the first lane set 305 may include three lanes of travel and the second lane set 307 may include four lanes of travel. The fast lane 104, first lane 106, second lane 108 and the exit lane 110 described above for FIG. 1B are examples of lanes of travel according to some implementations.

The first lane set 305 may be operable so that the traffic flows in a south-bound direction in some implementations.

The second lane set 307 may be operable so that the traffic flows in a north-bound direction in some implementations.

A traffic event 150 may be present in the second lane set 307. The traffic event 150 may be similar to the traffic event 150 described above for FIG. 1B, and so, that description will not be repeated here.

The first lane set 305 may include a fourth vehicle 123D.

The second lane set 307 may include a third vehicle 123C, a second vehicle 123B and a first vehicle 123A that are in a route that may be affected by the traffic event 150. One or more of the third vehicle 123C, the second vehicle 123B and the first vehicle 123A may be outside of sensor range of the traffic event 150.

The fourth vehicle 123D may detect the traffic event 150 via a sensor measurement 120A. The fourth vehicle 123D may store sensor data 196 describing the traffic event 150. The fourth vehicle 123D may transmit a DSRC message (or BSM or some other wireless message) to the third vehicle 123C. This DSRC message may be referred to as the “direct DSRC #1 message.” The direct DSRC #1 message may include the sensor data 196 describing the traffic event 150. The third vehicle 123C may receive the direct DSRC #1 message. In some implementations, the direct DSRC #1 message may be a BSM, DSRC probe or some other wireless message that includes the sensor data 196.

The second vehicle 123B or the first vehicle 123A may be outside of DSRC range of the fourth vehicle 123D so that they may not receive the direct DSRC #1 message. DSRC range may be approximately 1000 meters. The third vehicle 123C may transmit a DSRC message referred to as the “direct DSRC #2 message.” The direct DSRC #2 message may include the sensor data 196 describing the traffic event 150. The sensor data 196 included in the direct DSRC #2 message may describe the sensor measurements 120B of the third vehicle 123C and the sensor measurements 120A of the fourth vehicle 123D. The sensor measurements 120B of the third vehicle 123C may be different than the sensor data 196 sensor measurements 120A of the fourth vehicle 123D because the sensors of the third vehicle 123C may have a different prospective than the sensors of the fourth vehicle 123D. The direct DSRC #2 message may include sensor data 196 describing the sensor measurements 120A of the fourth vehicle 123D and the sensor measurements 120B of the third vehicle 123C. In some implementations, the direct DSRC #2 message may be a BSM, DSRC probe or some other wireless message that includes the sensor data 196.

The first vehicle 123A may be outside of DSRC range of the third vehicle 123C so that the first vehicle 123A may not receive the direct DSRC #2 message. The second vehicle 123B may transmit a DSRC message referred to as the “direct DSRC #3 message.” The direct DSRC #3 message may include the sensor data 196 describing the traffic event 150. The sensor data 196 included in the direct DSRC #3 message may describe sensor measurements 120A of the fourth vehicle 123D and sensor measurements 120B of the third vehicle 123C. The first vehicle 123A may receive the direct DSRC #3 message. In some implementations, the direct DSRC #3 message may be a BSM, DSRC probe or some other wireless message that includes the sensor data 196.

In this way the first vehicle 123A may receive sensor data 196 describing the traffic event 150 even though the first vehicle 123A may be outside of sensor range of the traffic event 150 or outside of DSRC range of one or more DSRC-enabled devices that have detected the traffic event 150 using one or more sensors.

In some examples, the traffic event 150 may be located outside of DSRC range for the first vehicle 123A. In these examples, sensor data 196 may still be provided to the first vehicle 123A as described above. The sensor data 196 may include, among other things, GPS data that describes a location of the traffic event 150 or the vehicles that transmitted the wireless message.

For example, relative to the first vehicle 123A, the second vehicle 123B, third vehicle 123C and the fourth vehicle 123D are “down the road vehicles” that are presently located in the future path or bearing of the first vehicle 123A. The second vehicle 123B, third vehicle 123C and the fourth vehicle 123D may cooperate to provide the direct DSRC #3 message to the first vehicle 123A that includes sensor data 196 describing the traffic event 150 as collected or observed by the third vehicle 123C and the fourth vehicle 123D. For example, the fourth vehicle 123D and the third vehicle 123C may collect sensor data 196 that describes the traffic event 150. The fourth vehicle 123D may send the direct DSRC #1 message to the third vehicle 123C that includes the sensor data 196 collected by the fourth vehicle 123D. The third vehicle 123C may send the direct DSRC #2 message to the second vehicle 123B that includes the sensor data 196 collected by the fourth vehicle 123D and the third vehicle 123C. The second vehicle 123B may send the direct DSRC #3 message to the first vehicle 123A that includes the sensor data 196 collected by the fourth vehicle 123D and the third vehicle 123C. In some implementations, one or more of the direct DSRC #1 message, the direct DSRC #2 message or the direct DSRC #3 message may include some other form of wireless message such as a full-duplex wireless message.

FIG. 3B is a block diagram illustrating an example operating environment 301 a plurality of devices 123, 198 including a micro-navigation system according to some implementations. In FIG. 3B the operating environment 301 includes a plurality of roadside units 198 (“RSU 198” if singular or “RSUs 198” if plural) that may be DSRC-enabled. One or more of the messages depicted in FIG. 3B may include a DSRC message, BSM, DSRC probe or some other wireless message that includes the sensor data 196.

FIG. 3B is similar to FIG. 3A with the exception that the first RSU 198A and the second RSU 198B may assist in providing the first vehicle 123A with sensor data 196.

In some implementations, DSRC-equipped vehicles may probe other DSRC-equipped vehicles (e.g., 123D, 123C, 123B, 123A) or devices (e.g., 198B, 198A) along the roadway for information describing their current or future conditions, including their path history and future path. This information may be described as “probe data.” The micro-navigation system 199 may provide micro-navigation suggestions based in part on such probe data. The probe data may be an element of the DSRC data 194 or some other data included in a wireless message (which may be a DSRC message or some other wireless message).

In some implementations, the DSRC data 194, BSM data 195 or the sensor data 196 included in a DSRC message may include GPS data that is precise enough to identify which lane a vehicle is traveling in. The BSM data 195, DSRC data 194 or DSRC probe data may specify which lane a vehicle is traveling in as well as its speed of travel and path history. The micro-navigation system 199 may use this information to provide micro-navigation suggestions since, based on the DSRC data 194 or the sensor data 196, it will have information that describes not only the location of the one or more traffic events 150 but also the location of the different vehicles that provided the sensor data 196 describing the one or more traffic events 150 (including the lane of travel of these vehicles and the future lanes of travel of these vehicles based on their respective path data, which is an element of the DSRC data 194 or the BSM data 195).

Optionally, a traffic event 150 be reported by some threshold number of vehicles 123 before a micro-navigation system 199 makes a micro-navigation suggestion for responding to the traffic event 150. Different traffic events 150 may be distinguished or identified by the micro-navigation system 199 based on the GPS data or time stamp data included in the DSRC data 194, BSM data 195 or the sensor data 196. The micro-navigation system 199 may also determine one or more confidence factors based on the quality or quantity of the sensor data 196 relating to a traffic event 150. For example, the sensor data 196 may include noise or some other factor that indicates that the sensor data 196 is of less quality and would therefore merit a lower quality score.

Optionally, some legacy vehicles may not be equipped with wireless technology(e.g., they may not include a communication unit 245. In some implementations the micro-navigation system 199 may improve the performance of these legacy vehicles by using a cloud server to push information (e.g., DSRC data 194, BSM data 195 or the sensor data 196) to the smartphones or other wireless-enabled devices of the drivers of these legacy vehicles. For example, the first vehicle 123A may be equipped a communication unit 245 and the first vehicle 123A may send information describing a traffic event 150 through 3G, 4G, LTE, DSRC or some other wireless communication message to the cloud server. The cloud server may then send that information to wireless devices of the drivers of the legacy vehicles via SMS, voice warning or some other format.

Referring now to FIG. 4A, depicted is a block diagram illustrating an example of the BSM data 195 according to some implementations.

The regular interval for transmitting BSMs may be user configurable. In some implementations, a default setting for this interval may be transmitting the BSM every 0.10 seconds or substantially every 0.10 seconds.

A BSM may be broadcasted over the 5.9 GHz DSRC band. DSRC range may be substantially 1,000 meters. In some implementations, DSRC range may include a range of substantially 100 meters to substantially 1,000 meters.

Referring now to FIG. 4B, depicted is a block diagram illustrating an example of BSM data 195 according to some implementations.

A BSM may include two parts. These two parts may include different BSM data 195 as shown in FIG. 4B.

Part 1 of the BSM data 195 may describe one or more of the following: vehicle position; vehicle heading; vehicle speed; vehicle acceleration; vehicle steering wheel angle; and vehicle size.

Part 2 of the BSM data 195 may include a variable set of data elements drawn from a list of optional elements. Some of the BSM data 195 included in Part 2 of the BSM are selected based on event triggers, e.g., anti-locking brake system (“ABS”) being activated may trigger BSM data 195 relevant to the ABS system of the vehicle.

In some implementations, some of the elements of Part 2 are transmitted less frequently in order to conserve bandwidth.

In some implementations, the BSM data 195 included in a BSM includes current snapshots of a vehicle traveling along a roadway system.

In some implementations, some or all of the information described above for the BSM data 195 may be included in the DSRC data 194.

FIG. 5 is a diagram illustrating an example of a navigation route 515 provided by a GPS-based navigation system according to some implementations. FIG. 5 is described above, and so, that description will not be repeated here.

Regarding U.S. patent application Ser. No. 14/471,387 filed on Aug. 28, 2014 and entitled “Full-Duplex Coordination System,” in a half-duplex communication system, a first communication device currently transmitting data to a second communication device is not capable of simultaneously receiving data from the second communication device. If the second communication device has data to transmit to the first communication device, the second communication device needs to wait until the first communication device completes its data transmission. Only one communication device is allowed to transmit data at one time in the half-duplex communication system.

In a standard IEEE 802.11 Wireless Local Area Network (WLAN), communication devices may compete for access to a wireless channel based on the Carrier Sense Multiple Access with Collision Avoidance (CSMA/CA) Medium Access Control (MAC) protocol. The IEEE 802.11 MAC protocol requires that only one communication device may use the wireless channel to transmit data at one time. If two or more communication devices transmit data over the wireless channel at the same time, a collision occurs. As a result, only the communication device that currently gains access to the wireless channel may use the wireless channel to transmit data. Other communication devices having data to transmit need to monitor the wireless channel and may compete for access to the wireless channel when the wireless channel becomes idle again.

According to one innovative aspect of the subject matter described in this disclosure, the vehicle 123 (and other communication devices such as the RSU 198) may include a full duplex coordination system for implementing full-duplex wireless communications. The full duplex coordination system may include a processor and a memory storing instructions that, when executed, cause the full duplex coordination system to: create, at a first communication device (such as a first vehicle 123A, a second vehicle 123B or an RSU 198), first data (such as any combination of the data stored on the memory 227) to transmit to a second communication device (such as a first vehicle 123A, a second vehicle 123B or an RSU 198); switch a half-duplex operation mode of the first communication device to a full-duplex operation mode to activate the full-duplex operation mode of the first communication device; transmit a first portion of the first data from the first communication device to the second communication device using a wireless channel; and transmit, in the full-duplex operation mode of the first communication device, a remaining portion of the first data to the second communication device while simultaneously receiving second data (such as any combination of the data stored on the memory 227) from the second communication device using the wireless channel.

According to another innovative aspect of the subject matter described in this disclosure, a full duplex coordination system for implementing full-duplex wireless communications includes a processor and a memory storing instructions that, when executed, cause the full duplex coordination system to: receive a first portion of first data (such as any combination of the data stored on the memory 227) from a first communication device via a wireless channel; determine that a second communication device is a single destination of the first data based on the first portion of the first data; determine that the second communication device has second data (such as any combination of the data stored on the memory 227) to transmit to the first communication device; determine that the first communication device has full-duplex communication capability; switch a half-duplex operation mode of the second communication device to a full-duplex operation mode to activate the full-duplex operation mode of the second communication device; and transmit, in the full-duplex operation mode of the second communication device, the second data to the first communication device while simultaneously receiving a remaining portion of the first data from the first communication device using the wireless channel.

In general, another innovative aspect of the subject matter described in this disclosure may be embodied in methods that include: creating, at a first communication device, first data to transmit to a second communication device; switching a half-duplex operation mode of the first communication device to a full-duplex operation mode to activate the full-duplex operation mode of the first communication device; transmitting a first portion of the first data from the first communication device to the second communication device using a wireless channel; and transmitting, in the full-duplex operation mode of the first communication device, a remaining portion of the first data to the second communication device while simultaneously receiving second data from the second communication device using the wireless channel.

Yet another innovative aspect of the subject matter described in this disclosure may be embodied in methods that include: receiving a first portion of first data from a first communication device via a wireless channel; determining that a second communication device is a single destination of the first data based on the first portion of the first data; determining that the second communication device has second data to transmit to the first communication device; determining that the first communication device has full-duplex communication capability; switching a half-duplex operation mode of the second communication device to a full-duplex operation mode to activate the full-duplex operation mode of the second communication device; and transmitting, in the full-duplex operation mode of the second communication device, the second data to the first communication device while simultaneously receiving a remaining portion of the first data from the first communication device using the wireless channel.

Another innovative aspect of the subject matter described in this disclosure may be embodied in methods that include: determining first data to transmit from a first communication device to a second communication device; and transmitting, from the first communication device that operates in a full-duplex operation mode, the first data to the second communication device while simultaneously receiving second data from the second communication device using a common wireless channel.

Another innovative aspect of the subject matter described in this disclosure may be embodied in methods that include: receiving, from a first communication device, first data at a second communication device via a wireless channel; determining second data to transmit from the second communication device to the first communication device responsive to receiving at least a portion of the first data; and transmitting, from the second communication device that operates in a full-duplex operation mode, the second data to the first communication device using the wireless channel while simultaneously receiving the first data from the first communication device.

Another innovative aspect of the subject matter described in this disclosure may be embodied in methods that include: determining, at a first communication device, first data to transmit to a second communication device; switching the first communication device from a half-duplex operation mode to a full-duplex operation mode; transmitting, in the full-duplex operation mode of the first communication device, the first data to the second communication device while simultaneously receiving second data from the second communication device using the wireless channel; and switching the full-duplex operation mode of the first communication device to the half-duplex operation mode responsive to a determination that transmission of the first data completes.

Another innovative aspect of the subject matter described in this disclosure may be embodied in methods that include: receiving, from a first communication device, first data at a second communication device via a wireless channel; determining that the second communication device has second data to transmit to the first communication device; switching the second communication device from a half-duplex operation mode to a full-duplex operation mode; transmitting, in the full-duplex operation mode of the second communication device, the second data to the first communication device while simultaneously receiving the first data from the first communication device using the wireless channel; and switching the full-duplex operation mode of the second communication device to the half-duplex operation mode responsive to a determination that transmission of the second data completes.

Other aspects include corresponding methods, systems, apparatus, and computer program products for these and other innovative aspects.

These and other implementations may each optionally include one or more of the following operations and features. For instance, the features include: the first data including a first packet and the first portion of the first data including a header portion of the first packet; the remaining portion of the first data including a payload portion and a trailer portion of the first packet; determining that the second communication device is a single destination of the first data; activating the full-duplex operation mode of the first communication device responsive to the second communication device being the single destination of the first data; the first communication device and the second communication device being communication devices in a wireless local area network; determining that the first communication device operates in a regulated spectrum where full-duplex communication capability is required; receiving device registry data associated with the first communication device; determining that the first communication device has full-duplex communication capability based on the device registry data; and determining that the first communication device has full-duplex communication capability based on a capability indication field in the first portion of the first data, the capability indication field including data describing whether the first communication device has full-duplex communication capability.

For instance, the operations include: determining that the wireless channel is idle; and accessing the wireless channel for data communication between the first communication device and the second communication device based on a channel access rule.

The disclosure is particularly advantageous in a number of respects. For example, the system described herein is capable of achieving a higher throughput and a faster communication speed using full-duplex communication technologies rather than using half-duplex communication technologies. The full-duplex communication may be implemented between vehicles (e.g., communication systems installed in vehicles 123 such as those depicted in FIGS. 1B, 1C, 3A and 3B) or other communication devices that have full-duplex communication capability. In another example, the system coordinates communication between communication devices in a distributed way without using a central coordinator. The system determines a pair of communication devices and coordinates simultaneous transmission of data between the pair of communication devices so that the pair of communication devices may transmit data to each other simultaneously using the same wireless channel. Meanwhile, other communication devices may not transmit data over the wireless channel to avoid collision. The advantages of the system described herein are provided by way of example, and the system may have numerous other advantages.

The disclosure includes a system and method for implementing full-duplex wireless communications between communication devices. A full-duplex coordination system may include a processor and a memory storing instructions that, when executed, cause the full-duplex coordination system to: create, at a first communication device, first data to transmit to a second communication device; switch a half-duplex operation mode of the first communication device to a full-duplex operation mode to activate the full-duplex operation mode of the first communication device; transmit a first portion of the first data from the first communication device to the second communication device using a wireless channel; and transmit, in the full-duplex operation mode of the first communication device, a remaining portion of the first data to the second communication device while simultaneously receiving second data from the second communication device using the wireless channel.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present implementations can be described above primarily with reference to user interfaces and particular hardware. However, the present implementations can apply to any type of computer system that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present implementations of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations or some implementations containing both hardware and software elements. In some preferred implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A method implemented by a computer system to provide a micro-navigation suggestion to a driver of a first vehicle, the method comprising:
detecting, by a DSRC-enabled device using a sensor set installed in the DSRC-enabled device, a traffic event, wherein the sensor set generates sensor data that describes the traffic event;
wirelessly transmitting, by a DSRC transmitter installed in the DSRC-enabled device, a DSRC message that includes the sensor data that describes the traffic event;
wirelessly receiving, by a DSRC receiver installed in a first vehicle, the DSRC message that includes the sensor data that describes the traffic event, wherein the first vehicle, the DSRC-enabled device and the traffic event are contemporaneously present on a roadway and the traffic event is located in a direction where the first vehicle is traveling so that the first vehicle is in motion and traveling in the direction of the traffic event on the roadway;
analyzing, by a micro-navigation system installed in the first vehicle, the sensor data to determine a micro-navigation suggestion for a driver of the first vehicle; and
providing the micro-navigation suggestion to the driver.

2. The method of claim 1, wherein the DSRC-enabled device is a second vehicle that is proximate to the traffic event.

3. The method of claim 1, wherein the DSRC-enabled device is a roadside unit that is proximate to the traffic event.

4. The method of claim 1, wherein the sensor set includes a camera and the sensor data includes an image of the traffic event and GPS data that describes an estimate of a location of the traffic event.

5. The method of claim 1, wherein the DSRC-enabled device is a second vehicle that is traveling in a lane that includes at least a portion of the traffic event, wherein the second vehicle includes a DSRC-compliant GPS unit that is operable to retrieve GPS data that describes a location of the second vehicle to a lane-level degree of precision and wherein the sensor data includes information that describes an estimate of the location of the traffic event with the lane-level degree of precision so that the first vehicle that receives the sensor data can determine the estimate of the location of the traffic event with the lane-level degree of precision.

6. The method of claim 5, wherein the lane-level degree of precision includes being accurate to within plus or minus 1.5 meters.

7. The method of claim 5, wherein the lane-level degree of precision includes being accurate to within substantially plus or minus 1.5 meters.

8. The method of claim 1, wherein the micro-navigation suggestion describes a new lane of travel.

9. The method of claim 1, wherein the micro-navigation suggestion describes a time to enter an exit lane.

10. The method of claim 9, wherein the micro-navigation suggestion is determined based on the sensor data and roadway data that describes a predetermined navigation route of the first vehicle, wherein the roadway data is determined by a navigation system included in the first vehicle.

11. The method of claim 1, wherein the micro-navigation suggestion describes a time to change to a new lane of travel.

12. The method of claim 1, wherein the micro-navigation suggestion describes a time to change to a fast lane.

13. The method of claim 1, wherein the micro-navigation suggestion describes a time to overtake a slower moving vehicle.

14. The method of claim 13, wherein the DSRC-enabled device is the slower moving vehicle so that the slower moving vehicle assists another vehicle to overtake the slower moving vehicle.

15. The method of claim 1, wherein the DSRC message is a basic safety message and the sensor data is included in a header of the basic safety message.

16. The method of claim 1, wherein the first vehicle is not within DSRC-range of the DSRC-enabled device and the DSRC message is received by the first vehicle as a relay message.

17. The method of claim 16, wherein the relay message is transmitted by a DSRC-equipped roadside unit that is stationary.

18. The method of claim 16, wherein the relay message is transmitted by a third vehicle that is DSRC-equipped.

19. A system to provide a micro-navigation suggestion to a driver of a first vehicle, the system comprising:
a DSRC-enabled device including a sensor set and a DSRC transmitter, wherein the sensor set is operable to detect a traffic event and generate sensor data that describes the traffic event and the DSRC transmitter is operable to wirelessly transmit a DSRC message that includes the sensor data; and
a vehicle that includes a DSRC receiver, a micro-navigation system and an output device, wherein the DSRC receive receives the DSRC message that includes the sensor data that describes the traffic event, the micro-navigation system analyzes the sensor data to determine suggestion data that describes a micro-navigation suggestion for a driver of the vehicle and the output device provides an output that describes the micro-navigation suggestion for the driver of the vehicle.

20. A computer program product including computer code stored on a non-transitory memory that, when executed by a processor, causes the processor to perform steps comprising
receiving a wireless message that includes sensor data that describes a traffic event affecting a route of travel for a vehicle, wherein the vehicle and the traffic event are present on a roadway included in the route of travel for the vehicle and the traffic event is located in a direction where the vehicle is traveling so that the vehicle is in motion and traveling in the direction of the traffic event;
analyzing the sensor data to determine a micro-navigation suggestion for a driver of the vehicle; and
providing the micro-navigation suggestion to the driver.

21. The computer program product of claim 20, wherein the wireless message is a DSRC message.

22. The computer program product of claim 20, wherein the wireless message is a full-duplex wireless message received during a full-duplex operation mode of a full-duplex coordination system included in the vehicle.

23. The computer program product of claim 20, wherein providing the micro-navigation suggestion to the driver includes depicting a GUI on a monitor of the vehicle that graphically describes the micro-navigation suggestion.

24. The computer program product of claim 20, wherein providing the micro-navigation suggestion to the driver includes playing audio via a speaker of the vehicle that audibly describes the micro-navigation suggestion.
